(19) United States
(12) Patent Application Publication
(10) Pub. No.: US 2026/0155457 A1
(43) Pub. Date: Jun. 4, 2026

(54) WOUND ELECTRODE ASSEMBLY

(71) Applicant: TOYOTA JIDOSHA KABUSHIKI KAISHA, Toyota-shi (JP)

(72) Inventors: Mitsuru TATEISHI, Toyota-shi (JP); Masashi UEDA, Toyota-shi (JP); Jun IZUMI, Toyota-shi (JP); Shizuka MASUOKA, Nagoya-shi (JP); Aya SATO, Nagoya-shi (JP); Yuji KATAYAMA, Okazaki-shi (JP); Tatsuya YAMAMOTO, Toyohashi-shi (JP); Keitaro MACHIDA, Hamamatsu-shi (JP)

(73) Assignee: TOYOTA JIDOSHA KABUSHIKI KAISHA, Toyota-shi (JP)

(21) Appl. No.: 19/365,660

(22) Filed: Oct. 22, 2025

(30) Foreign Application Priority Data
Dec. 4, 2024 (JP) 2024-211017

(51) Int. Cl. H01M 10/0587; H01M 50/474; H01M 50/486

(52) U.S. Cl. CPC H01M 10/0587; H01M 50/474; H01M 50/486

(57) ABSTRACT

In a wound electrode assembly, a first electrode and a second electrode having a different polarity from the first electrode are wound in a flat shape with a separator interposed between the first electrode and the second electrode. The wound electrode assembly includes: a first resin member wound around a winding axis; and a second resin member wound around the winding axis along the first resin member on the inner side of the first resin member. The linear expansion coefficient of the first resin member is greater than the linear expansion coefficient of the second resin member.

### CROSS-REFERENCE TO RELATED APPLICATION

This application claims priority to Japanese Patent Application No. 2024-211017 filed on Dec. 4, 2024. The disclosure of the above-identified application, including the specification, drawings, and claims, is incorporated by reference herein in its entirety.

### BACKGROUND

### 1. Technical Field

The present disclosure relates to wound electrode assemblies.

### 2. Description of Related Art

Japanese Unexamined Patent Application Publication No. 2019-096592 (JP 2019-096592 A) discloses a wound electrode assembly in which a cathode electrode and an anode electrode, both in the form of a sheet, are wound with a separator interposed therebetween. In this wound electrode assembly, an electrode in which a conductive layer and an active material layer are laminated in this order on the surface of an insulating substrate is used as at least one of the cathode electrode and the anode electrode. The conductive layer includes a first portion where the active material layer is applied and a second portion protruding from the first portion. A through hole penetrating in the thickness direction is provided in the second portion and in a portion of the insulating substrate corresponding to the second portion. In the present specification, the term “conductive” means “electrically conductive” unless specified otherwise.

### SUMMARY

In a wound electrode assembly, when a resin substrate having conductive layers on both sides is used as a substrate supporting an active material layer, there is a concern that circumferential creep characteristics may deteriorate due to the resin substrate, resulting in loosening of the wound electrode assembly.

The present disclosure has been made in view of the above issue, and an object thereof is to provide a wound electrode assembly that can reduce the possibility of loosening of the wound electrode assembly.

A wound electrode assembly according to the present disclosure is a wound electrode assembly in which a first electrode and a second electrode having a different polarity from the first electrode are wound in a flat shape with a separator interposed between the first electrode and the second electrode. The wound electrode assembly includes: a first resin member wound around a winding axis; and a second resin member wound around the winding axis along the first resin member on the inner side of the first resin member. The linear expansion coefficient of the first resin member is greater than the linear expansion coefficient of the second resin member.

In the above configuration, the second resin member is disposed along the first resin member on the inner side of the first resin member. Since the linear expansion coefficient of the first resin member is greater than that of the second resin member, the first resin member is more likely to expand than the second resin member, and the second resin member is more likely to contract than the first resin member. Accordingly, when a temperature change occurs, the expansion of the first resin member and the contraction of the second resin member cancel each other out, thereby reducing loosening of the wound electrode assembly.

In the wound electrode assembly according to the present disclosure, the first electrode may include a first substrate and a first active material layer. The first substrate may include the first resin member and a first conductive layer provided on the first resin member, and the first active material layer may be provided on the first conductive layer. The second electrode may include a second substrate and a second active material layer. The second substrate may include the second resin member and a second conductive layer provided on the second resin member, and the second active material layer may be provided on the second conductive layer.

With the above configuration, loosening of the wound electrode assembly can be reduced in a configuration in which both the first electrode and the second electrode include a resin member.

In the wound electrode assembly according to the present disclosure, the first electrode may include a first substrate and a first active material layer. The first substrate may include a resin substrate in which the first resin member and the second resin member are laminated, and a first conductive layer provided on the resin substrate. The first active material layer may be provided on the first conductive layer.

With the above configuration, loosening of the wound electrode assembly can be reduced in a configuration in which the first electrode includes the resin substrate in which the first resin member and the second resin member are laminated.

In the wound electrode assembly according to the present disclosure, the resin substrate may include an overlapping region that overlaps the first active material layer in a laminating direction in which the first resin member and the second resin member are laminated, and a non-overlapping region that does not overlap the first active material layer in the laminating direction. The proportion of the second resin member in the overlapping region in the laminating direction may be greater than the proportion of the second resin member in the non-overlapping region in the laminating direction.

A manufacturing process of an electrode typically includes a pressing step in which an active material layer and a substrate are pressed between a pair of rollers in order to fix the active material layer onto the substrate. In the pressing step, the region of the substrate that overlaps the active material layer is more likely to elongate because this region is pressed between the rollers.

In the above configuration, the second resin member is less likely to expand than the first resin member. Increasing the proportion of the second resin member in the overlapping region can reduce expansion of the resin substrate in the overlapping region. As a result, separation of the first active material layer due to expansion of the resin substrate can be reduced.

In the wound electrode assembly according to the present disclosure, the first resin member may contain polyethylene. The second resin member may contain polypropylene.

With the above configuration, the difference in linear expansion coefficient between polyethylene and polypropylene makes it possible to reduce loosening of the wound electrode assembly.

The present disclosure can provide a wound electrode assembly that can reduce the possibility of loosening of the wound electrode assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to a first embodiment;

FIG. 2 is an exploded perspective view of the battery according to the first embodiment;

FIG. 3 is a sectional view of the battery in FIG. 1, taken along line III-III and viewed in the direction of the arrows;

FIG. 4 is a cross-sectional view of a wound electrode assembly in FIG. 3, taken along line IV-IV and viewed in the direction of the arrows;

FIG. 5A is a sectional view of a first electrode in an unwound state according to the first embodiment; and

FIG. 5B is a sectional view of a second electrode in an unwound state according to the first embodiment;

FIG. 6A is a sectional view of a first electrode in an unwound state according to a second embodiment;

FIG. 6B is a sectional view of a second electrode in an unwound state according to the second embodiment; and

FIG. 7 is a sectional view of a first electrode in an unwound state according to a third embodiment.

### DETAILED DESCRIPTION OF EMBODIMENTS

Hereinafter, embodiments of the present disclosure will be described in detail with reference to the drawings. In the following embodiments, the same or common portions are denoted by the same signs throughout the drawings, and description thereof will not be repeated.

### First Embodiment

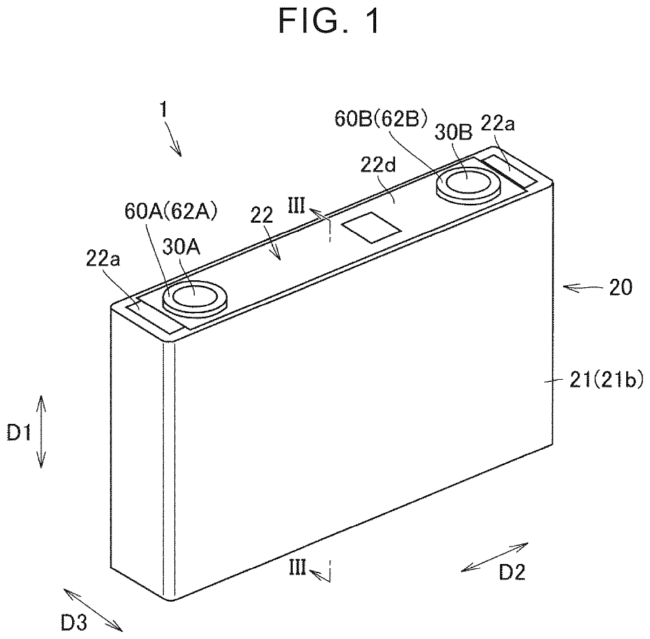

FIG. 1 is a perspective view of a battery according to a first embodiment. As shown in FIG. 1, a battery 1 according to the present embodiment is a so-called prismatic battery. The battery 1 may be a secondary battery configured to be charged and discharged such as a lithium-ion battery or a nickel metal hydride battery. The battery 1 may be used, for example, as a cell included in an energy storage module mounted on an electrified vehicle.

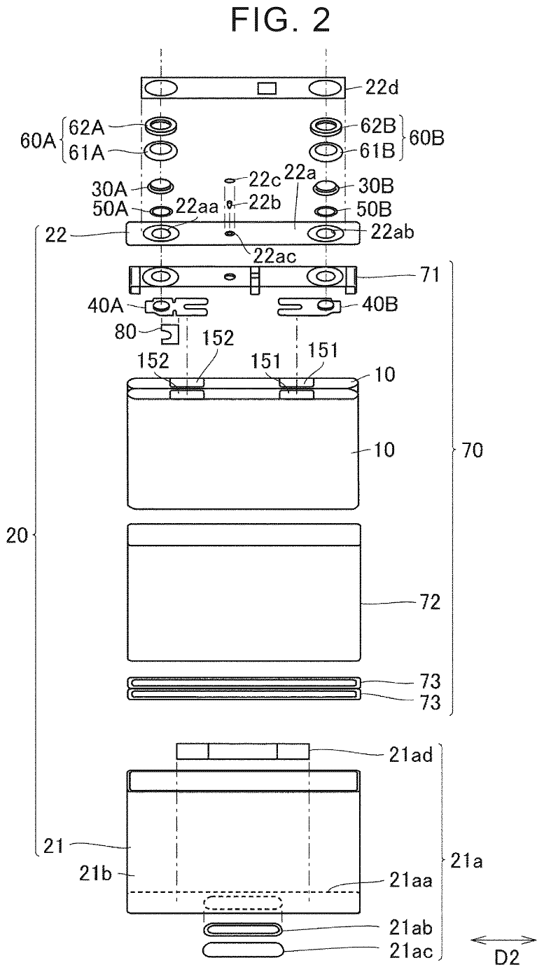

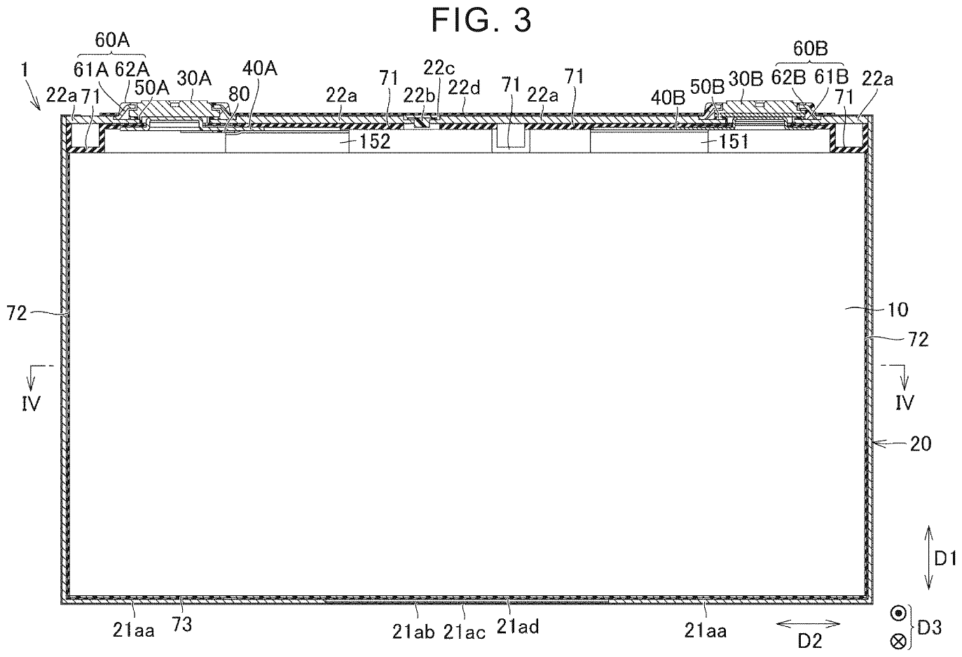

FIG. 2 is an exploded perspective view of the battery according to the first embodiment. FIG. 3 is a sectional view of the battery in FIG. 1, taken along line III-III and viewed in the direction of the arrows. As shown in FIGS. 1 to 3, the battery 1 of the first embodiment includes a wound electrode assembly 10, a case 20, a first external terminal 30A, a second external terminal 30B, a first connecting member 40A, a second connecting member 40B, a first seal ring 50A, a second seal ring 50B, a first terminal support portion 60A, a second terminal support portion 60B, an insulating member 70, and a fuse protection portion 80.

The case 20 is conductive. A conductive portion of the case 20 is made of, for example, a metal such as aluminum. The case 20 houses the wound electrode assembly 10. The case 20 also contains an electrolyte solution, not shown.

The case 20 includes a case body 21 and a lid 22. The case body 21 includes a bottom wall 21a and a peripheral wall 21b standing from the bottom wall 21a.

The bottom wall 21a includes a bottom body 21aa, a pressure relief valve 21ab, an outer protective film 21ac, and an inner protective film 21ad. The peripheral wall 21b stands from the bottom body 21aa. The pressure relief valve 21ab is provided in the bottom body 21aa. The outer protective film 21ac covers the pressure relief valve 21ab from the outside. The inner protective film 21ad covers the pressure relief valve 21ab from the inside. The bottom body 21aa and the pressure relief valve 21ab are made of a metal such as aluminum.

An opening is formed at the upper end of the peripheral wall 21b. The peripheral wall 21b has a substantially rectangular outer shape as viewed from the opening direction of the opening (the direction normal to the opening plane). The opening and the bottom wall 21a are arranged in a first direction D1. The first direction D1 may be the height direction or the up-down direction of the battery 1. The peripheral wall 21b is made of a metal such as aluminum.

The lid 22 includes a lid body 22a, a sealing plug 22b, a plug cover 22c, and an insulating cover 22d.

The lid body 22a is joined to the peripheral wall 21b by welding etc. so as to close the opening of the peripheral wall 21b. The lid body 22a has a first connecting hole 22aa, a second connecting hole 22ab, and a filling hole 22ac. The filling hole 22ac is a through hole for injecting an electrolyte solution into the case body 21 in a manufacturing process of the battery 1.

The sealing plug 22b seals the filling hole 22ac. The plug cover 22c covers the filling hole 22ac and the sealing plug 22b. The insulating cover 22d covers the filling hole 22ac, the sealing plug 22b, and the plug cover 22c.

The first external terminal 30A and the second external terminal 30B are provided in the battery 1 so as to be exposed to the outside. The first connecting member 40A and the second connecting member 40B are conductive. At least part of the first connecting member 40A and at least part of the second connecting member 40B are disposed inside the case 20.

The first external terminal 30A or the first connecting member 40A is inserted through the first connecting hole 22aa. The first external terminal 30A and the first connecting member 40A are joined together. The first connecting member 40A is joined to the wound electrode assembly 10. Accordingly, the first external terminal 30A is electrically connected to the wound electrode assembly 10.

The second external terminal 30B or the second connecting member 40B is inserted through the second connecting hole 22ab. The second external terminal 30B and the second connecting member 40B are joined together. The second connecting member 40B is joined to the wound electrode assembly 10. Accordingly, the second external terminal 30B is electrically connected to the wound electrode assembly 10.

In the present embodiment, the first external terminal 30A is a cathode terminal, and the second external terminal 30B is an anode terminal. The first external terminal 30A and the second external terminal 30B are arranged in a second direction D2. The second direction D2 is a direction perpendicular to the first direction D1.

The first seal ring 50A is provided along the first connecting hole 22aa. The first seal ring 50A is provided in a gap between the lid body 22a and the first external terminal 30A to seal the gap. The second seal ring 50B is provided along the second connecting hole 22ab. The second seal ring 50B is provided in a gap between the lid body 22a and the second external terminal 30B to seal the gap. The first seal ring 50A and the second seal ring 50B are electrically insulating.

The first terminal support portion 60A is retained by the lid body 22a. The first terminal support portion 60A supports the first external terminal 30A from the outer peripheral side of the first external terminal 30A. The first terminal support portion 60A includes a first retaining ring 61A and a first covering ring 62A. The first retaining ring 61A extends annularly so as to surround the first connecting hole 22aa, and is directly retained by the lid body 22a. The first covering ring 62A covers the first retaining ring 61A. The first retaining ring 61A supports the first external terminal 30A via the first covering ring 62A. The first covering ring 62A is a resin member that is electrically insulating or relatively weakly conductive.

The second terminal support portion 60B is retained by the lid body 22a. The second terminal support portion 60B supports the second external terminal 30B from the outer peripheral side of the second external terminal 30B. The second terminal support portion 60B includes a second retaining ring 61B and a second covering ring 62B. The second retaining ring 61B extends annularly so as to surround the second connecting hole 22ab, and is directly retained by the lid body 22a. The second covering ring 62B covers the second retaining ring 61B. The second retaining ring 61B supports the second external terminal 30B via the second covering ring 62B. The second covering ring 62B is a resin member that is electrically insulating.

The insulating member 70 is electrically insulating. The insulating member 70 is disposed between a plurality of the wound electrode assemblies 10 and the case 20. The insulating member 70 electrically insulates the wound electrode assemblies 10 from the case 20. The insulating member 70 includes an insulating bracket 71, a peripheral surface insulating portion 72, and a bottom surface insulating portion 73.

The insulating bracket 71 is disposed between the wound electrode assemblies 10 and the lid body 22a. The insulating bracket 71 has relatively high rigidity and is in contact with both the wound electrode assemblies 10 and the lid body 22a. The wound electrode assemblies 10 are thus fixed in the case 20 in the first direction D1.

The peripheral surface insulating portion 72 is disposed between the wound electrode assemblies 10 and the peripheral wall 21b. The peripheral surface insulating portion 72 is a member in the form of a film.

The bottom surface insulating portion 73 is disposed between each of the wound electrode assemblies 10 and the bottom wall 21a. The bottom surface insulating portion 73 is a member in the form of a film. In the present embodiment, the bottom surface insulating portion 73 is bonded to the wound electrode assembly 10. The bottom surface insulating portion 73 covers part of the bottom surface of the wound electrode assembly 10. The bottom surface insulating portion 73 may cover the entire bottom surface.

As shown in FIG. 2, the battery 1 according to the present embodiment includes a plurality of wound electrode assemblies 10. The battery 1 typically includes two wound electrode assemblies 10. The wound electrode assemblies 10 are arranged in a third direction D3. The third direction D3 is a direction perpendicular to both the first direction D1 and the second direction D2. The peripheral surface insulating portion 72 may integrally cover the wound electrode assemblies 10 such that the wound electrode assemblies 10 are secured together.

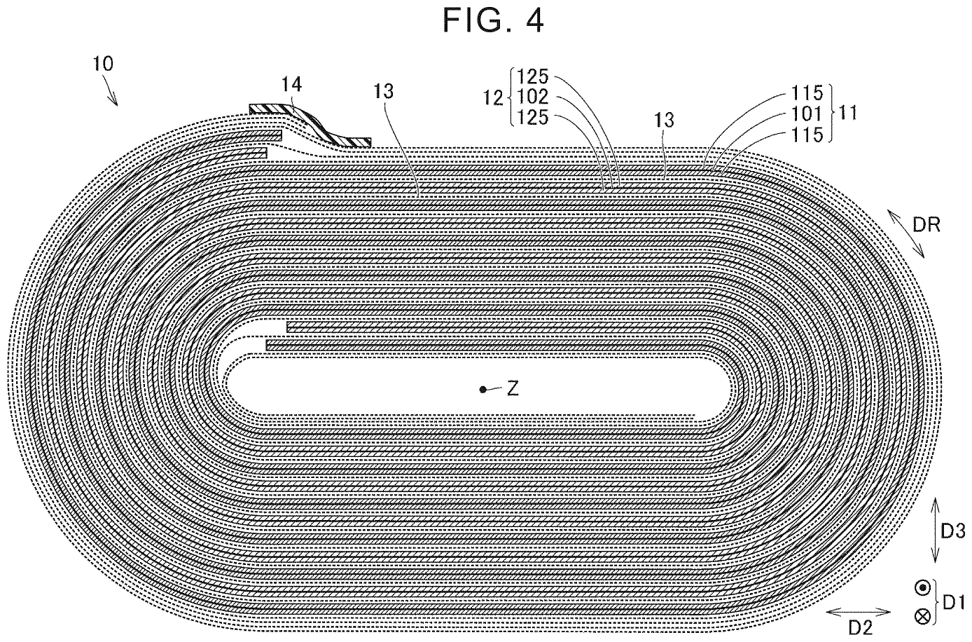

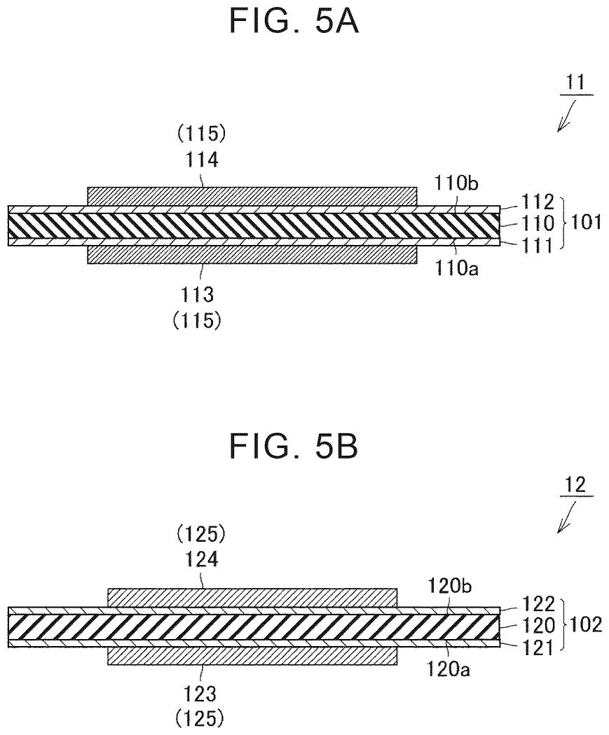

The wound electrode assembly 10 is provided with a plurality of first tabs 151 and a plurality of second tabs 152. A first end of each of the first tabs 151 is connected to first conductive layers 111, 112 (see FIGS. 5A, 5B) of a first electrode 11 (see FIG. 4) that will be described later. A second end of each of the first tabs 151 is joined to the second connecting member 40B by ultrasonic welding etc.

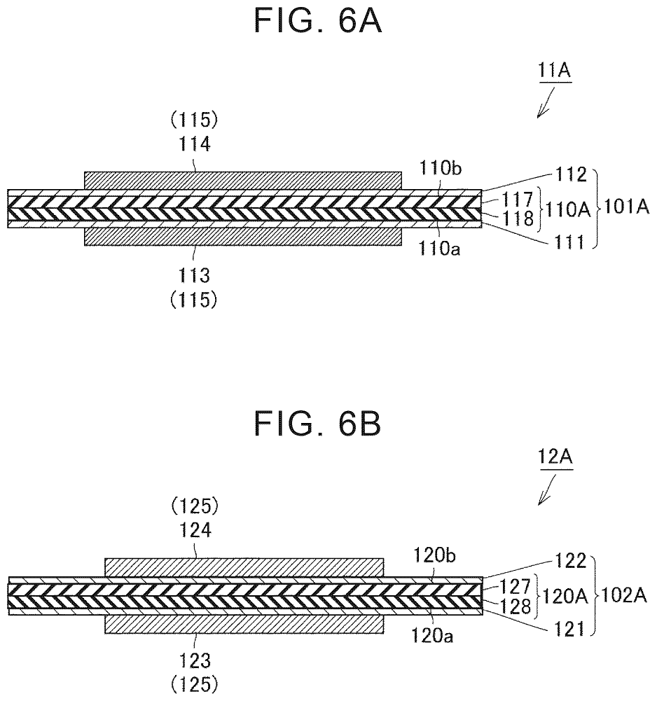

A first end of each of the second tabs 152 is connected to second conductive layers 121, 122 (see FIGS. 6A, 6B) of a second electrode 12 (see FIG. 4) that will be described later. A second end of each of the second tabs 152 is joined to the first connecting member 40A by ultrasonic welding etc.

FIG. 4 is a cross-sectional view of the wound electrode assembly in FIG. 3, taken along line IV-IV and viewed in the direction of the arrows. The wound electrode assembly 10 includes the first electrode 11, the second electrode 12, a separator 13, and a tape member 14. In the wound electrode assembly 10, the first electrode 11, the second electrode 12, and the separator 13 are wound around a winding axis Z. In FIG. 4, the separator 13 is schematically shown by dashed lines.

The first electrode 11 and the second electrode 12 are in the form of a sheet. The wound electrode assembly 10 is formed by winding the first electrode 11 and the second electrode 12 with one or more separators 13 interposed therebetween. For example, the first electrode 11 is an anode, and the second electrode 12 is a cathode.

The first electrode 11 includes a first substrate 101 and a first active material layer 115. The first active material layer 115 has the same polarity as the first electrode 11. The first active material layer 115 is, for example, an anode active material layer. A known material can be used as the anode active material layer. The first active material layer 115 is provided on the front and back surfaces of the first substrate 101.

The second electrode 12 includes a second substrate 102 and a second active material layer 125. The second active material layer 125 has the same polarity as the second electrode 12. The second active material layer 125 is, for example, a cathode active material layer. A known material can be used as the cathode active material layer. The second active material layer 125 is provided on the front and back surfaces of the second substrate 102.

The detailed structures of the first and second substrates 101, 102 will be described in detail later with reference to FIGS. 5A and 5B.

The separator 13 is provided between the first electrode 11 and the second electrode 12. The separator 13 separates the first electrode 11 from the second electrode 12 while allowing ions to travel between the first electrode 11 and the second electrode 12. The ions are, for example, lithium ions. The separator 13 is electrically insulating.

The separator 13 is located on the radially innermost side of the wound electrode assembly 10. The separator 13 is located on the radially outermost side of the wound electrode assembly 10. The outer peripheral edge of the separator 13 in a winding direction DR is fixed by the tape member 14 placed on the outer peripheral surface of the separator 13.

The separator 13 may contain, for example, a polyolefin-based resin etc. For example, the separator 13 may be made substantially of a polyolefin-based resin. The polyolefin-based resin may include, for example, at least one selected from the group consisting of polyethylene (PE) and polypropylene (PP).

FIGS. 5A and 5B are sectional views of the first electrode and the second electrode in an unwound state according to the first embodiment. FIG. 5A is a sectional view of the first electrode, and FIG. 5B is a sectional view of the second electrode. FIGS. 5A and 5B show sections perpendicular to the thickness direction of each electrode.

As shown in FIG. 5A, the first substrate 101 of the first electrode 11 includes a first resin member 110 and first conductive layers 111, 112 formed on the first resin member 110.

The first resin member 110 has a first surface 110a and a second surface 110b in a thickness direction. The thickness direction is parallel to a laminating direction in which the first substrate 101 and the first active material layer 115 are laminated. The linear expansion coefficient of the first resin member 110 is greater than that of a second resin member 120 that will be described later.

The first conductive layer 111 is formed on the first surface 110a, and the first conductive layer 112 is formed on the second surface 110b. The first conductive layers 111, 112 are made of a metal material containing copper. The first conductive layers 111, 112 may be respectively formed on the first and second surfaces 110a, 110b by vapor deposition etc. The first conductive layers 111, 112 may be made of metal foil, and may be respectively bonded to the first and second surfaces 110a, 110b by an adhesive.

The first active material layer 115 is formed on the first conductive layers 111, 112. Specifically, the first active material layer 115 is formed on central portions of the first conductive layers 111, 112 in the width direction.

The first active material layer 115 includes a first portion 113 and a second portion 114. The first portion 113 is formed on the first conductive layer 111. The second portion 114 is formed on the first conductive layer 112.

As shown in FIG. 5B, the second substrate 102 of the second electrode 12 includes a second resin member 120 and second conductive layers 121, 122 formed on the second resin member 120.

The second resin member 120 has a first surface 120a and a second surface 120b in a thickness direction. The thickness direction is parallel to a laminating direction in which the second substrate 102 and the second active material layer 125 are laminated.

The second conductive layer 121 is formed on the first surface 120a, and the second conductive layer 122 is formed on the second surface 120b. The second conductive layers 121, 122 are made of a metal material containing copper. The second conductive layers 121, 122 may be respectively formed on the first and second surfaces 120a, 120b by vapor deposition etc. The second conductive layers 121, 122 may be made of metal foil, and may be respectively bonded to the first and second surfaces 120a, 120b by an adhesive.

The second active material layer 125 is formed on the second conductive layers 121, 122. Specifically, the second active material layer 125 is formed on central portions of the second conductive layers 121, 122 in the width direction.

The second active material layer 125 includes a first portion 123 and a second portion 124. The first portion 123 is formed on the second conductive layer 121. The second portion 124 is formed on the second conductive layer 122.

As shown in FIGS. 4 to 6B, in the wound electrode assembly 10, the first resin member 110 is wound around the winding axis Z, and the second resin member 120 is wound around the winding axis Z along the first resin member 110 on the inner side of the first resin member 110.

As described above, the linear expansion coefficient of the first resin member 110 is greater than that of the second resin member 120. Therefore, the first resin member 110 is more likely to expand than the second resin member 120, and the second resin member 120 is more likely to contract than the first resin member 110.

Accordingly, when a temperature change occurs, the expansion of the first resin member 110 and the contraction of the second resin member 120 cancel each other out, thereby reducing loosening of the wound electrode assembly.

For example, when the linear expansion coefficient of the first resin member 110 is greater than that of the second resin member 120, the first resin member 110 may be made of polyethylene, and the second resin member 120 may be made of polypropylene. However, the materials of the resin members are not limited to these as long as the above relationship between the linear expansion coefficients is satisfied.

The linear expansion coefficients of both the first resin member 110 and the second resin member 120 may be positive. However, when the linear expansion coefficient of the first resin member 110 is positive and the linear expansion coefficient of the second resin member 120 is negative, the cancellation between expansion and contraction described above can further be enhanced.

### Second Embodiment

FIGS. 6A and 6B are sectional views of a first electrode and a second electrode in an unwound state according to a second embodiment. FIG. 6A is a sectional view of the first electrode, and FIG. 6B is a sectional view of the second electrode.

As shown in FIGS. 6A and 6B, a wound electrode assembly of the second embodiment is different from the wound electrode assembly 10 of the first embodiment in the configuration of a first substrate 101A and a second substrate 102A. The configuration of the wound electrode assembly of the second embodiment is otherwise substantially the same as the configuration of the wound electrode assembly 10 of the first embodiment.

The first substrate 101A of a first electrode 11A includes a first resin substrate 110A and the first conductive layers 111, 112. The first resin substrate 110A includes a first resin member 117 and a second resin member 118. The first resin member 117 and the second resin member 118 are laminated in the thickness direction of the first resin substrate 110A. The first resin member 117 and the second resin member 118 have a flat plate shape.

In the wound electrode assembly, the first resin member 117 is located on the outer side, and the second resin member 118 is located on the inner side. That is, in the wound electrode assembly, the second resin member 118 is wound around the winding axis Z along the first resin member 117 on the inner side of the first resin member 117.

The first resin substrate 110A has the first surface 110a and the second surface 110b in the thickness direction. The first surface 110a is defined by the second resin member 118, and the second surface 110b is defined by the first resin member 117.

The first conductive layer 111 is formed on the first surface 110a. The first conductive layer 112 is formed on the second surface 110b. The first active material layer 115 is formed on each of the first conductive layers 111, 112.

The second substrate 102A of a second electrode 12A includes a second resin substrate 120A and the second conductive layers 121, 122. The second resin substrate 120A includes a third resin member 127 and a fourth resin member 128. The third resin member 127 and the fourth resin member 128 are laminated in the thickness direction of the second resin substrate 120A. The third resin member 127 and the fourth resin member 128 have a flat plate shape.

In the wound electrode assembly, the third resin member 127 is located on the outer side, and the fourth resin member 128 is located on the inner side. That is, in the wound electrode assembly, the fourth resin member 128 is wound around the winding axis Z along the third resin member 127 on the inner side of the third resin member 127.

The second resin substrate 120A has the first surface 120a and the second surface 120b in the thickness direction. The first surface 120a is defined by the fourth resin member 128, and the second surface 110b is defined by the third resin member 127.

The second conductive layer 121 is formed on the first surface 120a. The second conductive layer 122 is formed on the second surface 120b. The second active material layer 125 is formed on each of the second conductive layers 121, 122.

In the second embodiment, in the first electrode 11A, the linear expansion coefficient of the first resin member 117 is greater than that of the second resin member 118. Therefore, the first resin member 117 is more likely to expand than the second resin member 118, and the second resin member 118 is more likely to contract than the first resin member 117.

Accordingly, as in the first embodiment, when a temperature change occurs, the expansion of the first resin member 117 and the contraction of the second resin member 118 cancel each other out, thereby reducing loosening of the wound electrode assembly.

In the second electrode 12A as well, the linear expansion coefficient of the third resin member 127 is greater than that of the fourth resin member 128. Therefore, the third resin member 127 is more likely to expand than the fourth resin member 128, and the fourth resin member 128 is more likely to contract than the third resin member 127.

Accordingly, in the second electrode 12A as well, when a temperature change occurs, the expansion of the third resin member 127 and the contraction of the fourth resin member 128 cancel each other out, thereby more effectively reducing loosening of the wound electrode assembly.

As an example of the first resin member 117 and the second resin member 118, the first resin member 117 may be made of polyethylene, and the second resin member 118 may be made of polypropylene. However, the materials of the resin members are not limited to these as long as the above relationship between the linear expansion coefficients is satisfied.

Similarly, as an example of the third resin member 127 and the fourth resin member 128, the third resin member 127 may be made of polyethylene, and the fourth resin member 128 may be made of polypropylene. However, the materials of the resin members are not limited to these as long as the above relationship between the linear expansion coefficients is satisfied.

### Third Embodiment

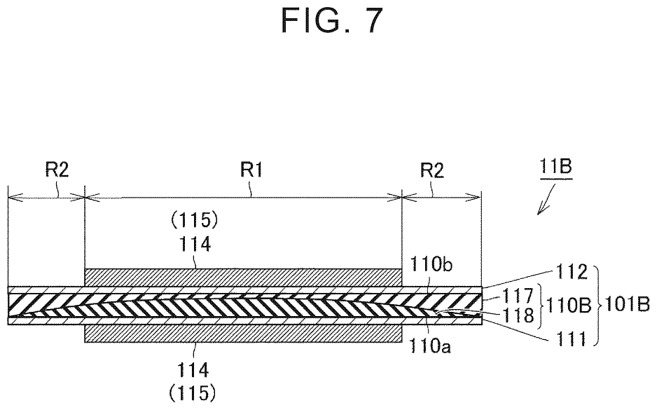

FIG. 7 is a sectional view of a first electrode in an unwound state according to a third embodiment. A first electrode 11B according to the third embodiment will be described with reference to FIG. 7.

As shown in FIG. 7, the first electrode 11B of the third embodiment is different from the first electrode 11A of the second embodiment in the configuration of a first resin substrate 110B, more specifically, in the shapes of the first resin member 117 and the second resin member 118. The configuration of the first electrode 11B of the third embodiment is otherwise substantially the same as the configuration of the first electrode 11A of the second embodiment.

The first resin substrate 110B includes: an overlapping region R1 that overlaps the first active material layer 115 in the laminating direction in which the first resin member 117 and the second resin member 118 are laminated; and a non-overlapping region R2 that does not overlap the first active material layer 115 in the laminating direction. In the first resin substrate 110B, the overlapping region R1 is located in the central portion in the width direction. The non-overlapping region R2 is located on both outer sides of the overlapping region R1 in the width direction.

The first resin member 117 has a concave shape in which its central portion in the width direction is curved toward the second surface 110b. The second resin member 118 has a convex shape in which its central portion in the width direction is curved toward the second surface 110b.

The proportion of the second resin member 118 in the overlapping region R1 in the laminating direction is greater than the proportion of the second resin member 118 in the non-overlapping region R2 in the laminating direction.

The proportion of the second resin member 118 in the overlapping region R1 is greater than the proportion of the first resin member 117 in the overlapping region R1. The proportion of the second resin member 118 in the non-overlapping region R2 is smaller than the proportion of the first resin member 117 in the overlapping region R1.

Even with this configuration, the wound electrode assembly including the first electrode 11B according to the third embodiment has substantially the same effects as those of the wound electrode assembly of the second embodiment.

In addition, in the overlapping region R1, the proportion of the second resin member 118 that is less likely to expand than the first resin member 117 is greater. This can reduce elongation of the first resin substrate 110B in the overlapping region R1 when the first active material layer 115 and a first substrate 101B are pressed between a pair of rollers during the manufacture of the electrode. It is therefore possible to reduce separation of the first active material layer 115 due to expansion of the first resin substrate 110B.

In the third embodiment, the third resin member 127 and the fourth resin member 128 of the second electrode may also have the same relationship as that between the first resin member 117 and the second resin member 118 described above. That is, the third resin member 127 may have a concave shape in which its central portion in the width direction is curved toward the second surface 120b, and the fourth resin member 128 may have a convex shape in which its central portion in the width direction is curved toward the second surface 120b.

In the overlapping region in which the second resin substrate overlaps the second active material layer 125 and the non-overlapping region in which the second resin substrate overlaps the second active material layer 125, the proportion of the fourth resin member 128 in the overlapping region in the laminating direction may be greater than the proportion of the fourth resin member 128 in the non-overlapping region in the laminating direction.

The proportion of the fourth resin member 128 in the overlapping region of the second resin substrate may be greater than the proportion of the third resin member 127 in this overlapping region. The proportion of the fourth resin member 128 in the non-overlapping region of the second resin substrate may be smaller than the proportion of the third resin member 127 in the overlapping region thereof.

### Other Modifications

The first to third embodiments described above illustrate the case where the first electrode 11 is an anode and the second electrode is a cathode. However, the present disclosure is not limited to this. The first electrode 11 may be a cathode and the second electrode may be an anode. In this case, the members constituting the first electrode 11 and the second electrode 12 may be selected according to the polarity of the corresponding substrate.

In the first to third embodiments, the separator 13 may also have a laminated structure in which a first resin and a second resin are laminated, like the first resin substrate 110A according to the second embodiment. In this case, in the wound electrode assembly, the second resin may be wound around the winding axis Z along the first resin on the inner side of the first resin. The linear expansion coefficient of the first resin may be greater than that of the second resin. For example, polyethylene may be used as the first resin, and polypropylene may be used as the second resin. However, the materials of the first and second resins are not limited to these as long as the above relationship between the linear expansion coefficients is satisfied.

The embodiments disclosed herein should be considered to be illustrative in all respects and not restrictive. The scope of the present disclosure is set forth in the claims, and includes all modifications within the meaning and scope equivalent to the claims.

What is claimed is:

1. A wound electrode assembly in which a first electrode and a second electrode having a different polarity from the first electrode are wound in a flat shape with a separator interposed between the first electrode and the second electrode, the wound electrode assembly comprising:
a first resin member wound around a winding axis; and
a second resin member wound around the winding axis along the first resin member on an inner side of the first resin member,
wherein a linear expansion coefficient of the first resin member is greater than a linear expansion coefficient of the second resin member.

2. The wound electrode assembly according to claim 1, wherein:
the first electrode includes a first substrate and a first active material layer, the first substrate including the first resin member and a first conductive layer provided on the first resin member, and the first active material layer being provided on the first conductive layer; and
the second electrode includes a second substrate and a second active material layer, the second substrate including the second resin member and a second conductive layer provided on the second resin member, and the second active material layer being provided on the second conductive layer.

3. The wound electrode assembly according to claim 1, wherein the first electrode includes a first substrate and a first active material layer, the first substrate including a resin substrate in which the first resin member and the second resin member are laminated, and a first conductive layer provided on the resin substrate, and the first active material layer being provided on the first conductive layer.

4. The wound electrode assembly according to claim 3, wherein:
the resin substrate includes an overlapping region that overlaps the first active material layer in a laminating direction in which the first resin member and the second resin member are laminated, and a non-overlapping region that does not overlap the first active material layer in the laminating direction; and
a proportion of the second resin member in the overlapping region in the laminating direction is greater than a proportion of the second resin member in the non-overlapping region in the laminating direction.

5. The wound electrode assembly according to claim 1, wherein:
the first resin member contains polyethylene; and
the second resin member contains polypropylene.
